(19) United States
(12) Patent Application Publication
(10) Pub. No.: US 2020/0047835 A1
(43) Pub. Date: Feb. 13, 2020

(54) APPARATUS FOR A CYCLING CHEST SUPPORT

(71) Applicant: Seth Bracewell, Sarasota, FL (US)

(72) Inventor: Seth Bracewell, Sarasota, FL (US)

(21) Appl. No.: 16/058,351

(22) Filed: Aug. 8, 2018

(51) Int. Cl. B62J 1/28; B62J 99/00

(52) U.S. Cl. CPC B62J 1/28; B62J 2099/0073; B62J 99/00

(57) ABSTRACT

A chest support device is presented. The chest support device has a flexible shaft. The flexible shaft has a shock absorbing structure that has a proximal end and a distal end. The proximal end is coupled to a chest cushion and the distal end of the shock absorbing structure is coupled to a bicycle frame and the coupling between the shock absorbing structure and the bicycle frame allows for the shock absorbing structure to be removable.

### FIELD OF THE INVENTION

The device of this invention resides in the field of bicycles and more particularly relates to a device for supporting the chest of a bicyclist when riding a bicycle.

### BACKGROUND

Bicycles with handles that curve downward for grasping enable a bicyclist to position his/her body in a low, aerodynamic position. Bicycle accessories referred to as Aerobars have been developed to enable a bicyclist to remain in such low position with elbows resting on supports and with a projection extending forward which the bicyclist can grasp for steering control.

Maintaining a low, aerodynamic position for long periods of time is difficult for a bicyclist and causes the rider's shoulders to hunch upwards, causing tension and strain in the back and torso of the rider. Fatigue builds up over time in the bicyclist who supports his body on either handlebars or on Aerobars.

Not only do riders fatigue, but they also have pressure on their backs, and shoulders. The stress increases on the arms, wrists and groin areas of the rider causing such discomfort as numbness, soreness as well as the aforementioned fatigue.

There is a need to reduce the stress and provide comfort to bicycle riders to increase the pleasure a rider has. This is good for society as the more people that ride and the longer they ride is commonly known to increase cardiovascular health.

There is also a need to provide a cycling support device that is portable, light weight and adjustable. These allow a rider to move the device from one bicycle to another bicycle easily and others to use the cycling support device when the rider is not using it.

### BRIEF DESCRIPTION OF THE DRAWINGS

FIG. 1 is a view of a bicycle.

FIG. 2 is a side view of an exemplary cycling support device.

FIG. 3 is a view of a rider on a bicycle with the exemplary cycling support device.

FIG. 4 is an exemplary view of a first position of the cycling support device.

FIG. 5 is an exemplary view of a second position of the cycling support device.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

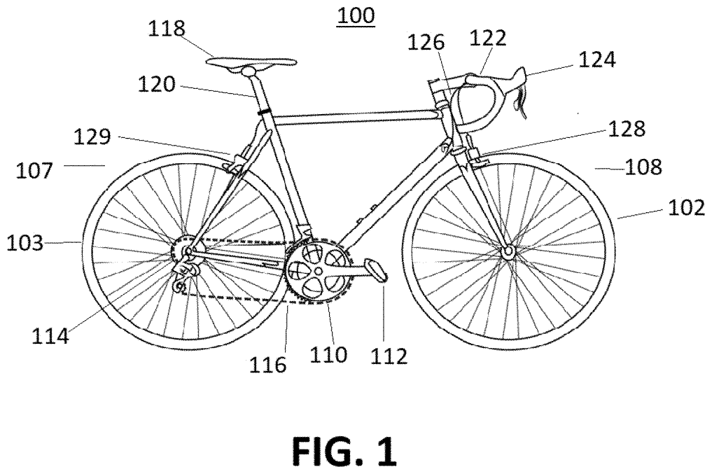

Referring now to FIG. 1, a bicycle 100 is presented. The bicycle 100 is useful for cheap and fun transportation. The bicycle 100 is also used in racing and other activities. The bicycle 100 is also used for training and conditioning. When the bicycle is ridden by a rider, the rider has many health benefits such as better cardiovascular health, help in controlling weight, better lung function and toning of the muscles. The bicycle 100 shown is of one style, but it is commonly known that there are many styles and makes of bicycles and any could readily be used for this example.

The bicycle 100 has two wheels 102, 103, but may have training wheels or other devices attached which may increase the number of wheels but still referred to as a bicycle. The bicycle 100 has a frame 106. The wheel 102 is coupled to a distal end 107 of the frame 106 of the bicycle 100 and the wheel 103 is coupled to a proximal end 108 of the frame 106 of the bicycle 100.

The bicycle 100 has a sprocket 110. The sprocket 110 is coupled from a pair of foot pedals 112 to a gear 114 by a chain 116. The gear 114 is coupled to the wheel 103 which turns the wheel 104 in a forward or a reverse direction. The bicycle 100 is moved in a direction by pedaling the foot pedals 112 and moving the chain 116, thus engaging the gears 114 and moving the wheel 103.

The frame 106 of the bicycle 100 further has a seat 118. The seat 118 allows a place for a rider to sit while pedaling the foot pedals 112 of the bicycle 100. The seat 118 is coupled to the frame 106 of the bicycle 100 by a seat post 120. The seat post 120 is adjustable to fit the length and desire position of a rider.

Also coupled to the frame 106 of the bicycle 100 is a handle bar 122. The handle bar 122 of the bicycle 100 is used to steer the bicycle 100 by moving the wheel 102 in the direction the rider is manipulating the handle bar 122 of the bicycle. The handle bar 122 of the bicycle 100 also has braking handles 124 and may have a gear shifter (not shown).

The braking handles 124 are coupled to the wheel 102 and the wheel 103 by a cable 126. When pressure is applied to the brake handle 124 of the bicycle 100, the brakes 128, 129 are pulled against the wheel 102, 103 by the tension applied to the cable 126. When the brake handle 124 is released, the tension is eased on the cable 126 and the brakes 128, 129 are relaxed and are no longer in contact with the wheels 102, 103.

The gear shifter (not shown) is useful when the bicycle 100 has multiple gears. The changing of the gear shifter allows for the rider to adjust the difficulty in pedaling the bicycle 100.

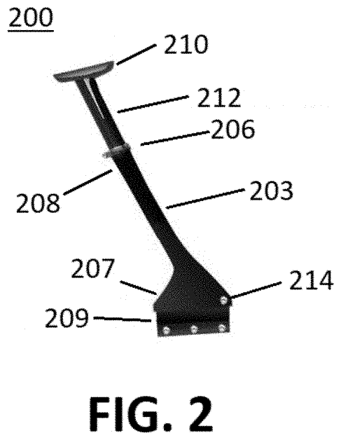

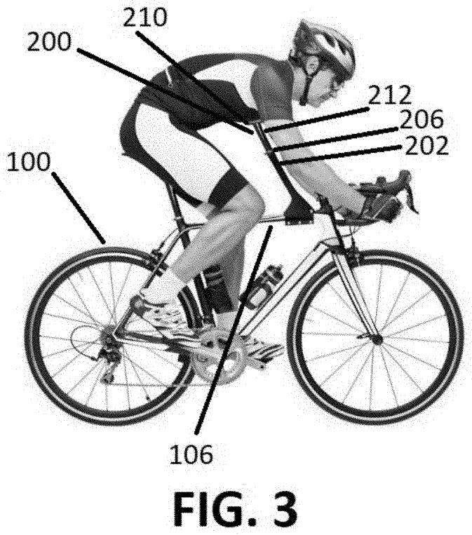

Referring now to FIG. 2, an exemplary cycling support device 200 is shown. The cycling support device 200 is useful to a rider of a bicycle 100 so that the rider is more comfortable when riding the bicycle 100. The rider can lean against the cycling support device 200 to alleviate strain and stress on various parts of the rider's body. The cycling support device 200 is of such a size that allows the rider to lean against it but does not hinder the rider from moving from side to side.

The cycling support device 200 is also of a size that it allows the handle bar 122 of the bicycle 100 to move easily without being unduly restricted, thus allowing the rider to have control of the bicycle 100 such that the bicycle 100 is controllable not differently when the bicycle 100 has the cycling support device 200 or when the bicycle 100 does not have the cycling support device 200.

The cycling support device 200 has a shaft 202. The shaft 202 is made of a material that is light and easily movable by a rider. The shaft may be constructed of a light, strong metal, polyvinyl chloride, aluminum, carbon fiber, plastic, etc.

The shaft 202 may be made in one piece or in multiple pieces 203, 204. The shaft 202 may be made of multiple pieces where the multiple pieces fit together at different lengths to accommodate different sized riders. The multiple pieces of the shaft 202 is adjustable to different lengths to accommodate the different riders. The shaft 202 further has a quick release clamp 206. The quick release clamp 206 allows the rider to quickly adjust the position of the chest cushion of the cycling support device 200 to a desired comfortability.

The stem 212 connects the shaft 202 to the chest cushion 210 and can either be ridged or include a suspension component (not shown) for additional comfort.

The shaft 202 has a distal end 207 and a proximal end 208. The distal end 207 of the shaft 202 has a coupler 209. The coupler 209 of the shaft 202 is used to couple the shaft 202 to the bicycle 100. The shaft 202 may be connected to the coupler 209 at different angles to facilitate different rider positions, typically between 15 and 30 degrees towards the rider. The coupler 209 is made of a semi-ridged rubber material to allow the shaft 202 and entire chest support system 200 to modestly flex with the movement of the rider. A pivot pin 214 couples the distal end 207 of the stem 202 to the coupler 209.

The proximal end 208 of the shaft 202 is coupled to a chest cushion 210. The chest cushion 210 may be made of any material such as vinyl, cloth, leather, sheepskin, etc. The chest cushion 210 may be padded. The padding of the chest cushion may be down feathers, foam, microfiber, etc. The chest cushion 210 may come in different shapes based on the rider's gender and comfort requirements.

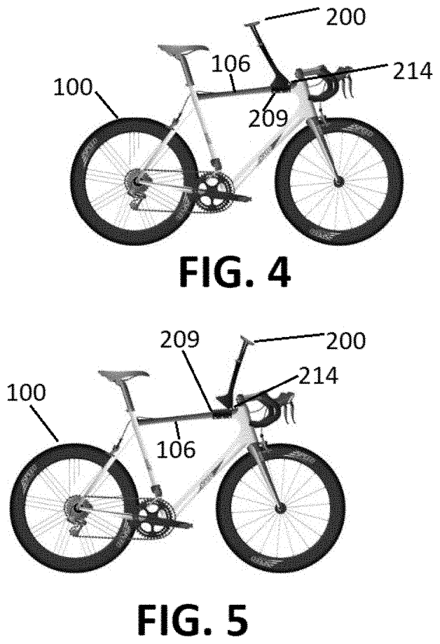

Moving now to FIG. 4, the bicycle 100 is shown equipped with the cycling support device 200 of FIG. 2. The bicycle 100 has the cycling support 200 coupled to the frame 106 of the bicycle 100.

The cycling support system 200 has been adjusted by releasing the quick release clamp 206 and allowing the stem 212 to move up and down freely within the shaft 202. Thus, the shaft 202 has been positioned to a comfortable and supportive position for the rider.

The chest cushion 210 is positioned at the chest level of the rider and thus supporting the rider and making the ride of the bicycle 100 to be more comfortable and less stress upon the rider.

The chest support device 200 has been angled for maximum support and comfort of the rider and is coupled to the frame 106 of the bicycle 100. The connector 209 of the chest support device 200 is coupled to the frame 106 of the bicycle 100 with a hinged connector.

Moving now to FIG. 4 and FIG. 5. The chest supporting device 200 has been placed into its normal positon in FIG. 4. The pivot pin 214 is the connection point for connecting the coupler 209 and the distal end 207 of the shaft 202. The coupler 209 is coupled to the frame 106 of the bicycle 100.

FIG. 5, shows the shaft 202 has been moved to a different angle but is still coupled to the coupler 209. The pivot pin 214 is the hinge point of the movement of the coupler 209 and the distal end 207 of the shaft 202. The coupler 209 is coupled to the frame 106 of the bicycle 100.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A chest support device, the chest support device comprising:
a flexible shaft, the flexible shaft having a shock absorbing structure the shock absorbing structure having a proximal end and a distal end;
a chest cushion, the chest cushion coupled to the proximal end of the shock absorbing structure; and
a bicycle frame, the bicycle frame being coupled to the distal end of the shock absorbing structure for attaching the device to the bicycle.

2. The chest support device of claim 1, wherein the chest cushion shape being triangular.

3. The chest support device of claim 1, wherein the chest cushion shape being round.

4. The chest support device of claim 1, wherein the chest cushion material is a vinyl material.

5. The chest support device of claim 1, wherein the chest cushion is a cloth material.

6. The chest support device of claim 1, wherein the shock absorbing structure is a light weight metal material.

7. The chest support device of claim 1, wherein the shock absorbing structure is a polyvinyl chloride (PVC).

8. The chest support device of claim 1, wherein the shaft is flexible.

9. The chest support device of claim 1, wherein the shaft is made of a same material as the shock absorbing structure.

10. The chest support device of claim 1, wherein the shaft is polyvinyl chloride (PVC).

11. The chest support device of claim 1, wherein the coupling of the bicycle frame and the shaft is a hinge.

12. The chest support device of claim 1, wherein the coupling of the bicycle frame and the shaft is a coupling that has screws, the screws being removable to release the shaft from the bicycle frame.

13. The chest support device of claim 1, wherein the coupling of the bicycle frame and the shaft is a hinged coupling the hinged coupling being adjustable to one or more angles.

14. The chest support device of claim 1, wherein the shaft is adjustable in length.

15. The chest support device of claim 14, wherein the shaft is adjustable using a quick release clamp.
